(19) United States
(12) Patent Application Publication
(10) Pub. No.: US 2007/0041447 A1
(43) Pub. Date: Feb. 22, 2007

(54) Content analysis of coded video data

(76) Inventors: Dzevdet Burazerovic, Eindhoven (NL); Jan Alexis Daniel Nesvadba, Eindhoven (NL); Freddy Snijder, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,765

(22) PCT Filed: Apr. 13, 2004
(86) PCT No.: PCT/IB04/50428

§ 371 Date: Oct. 12, 2005

(51) Int. Cl. H04N 11/04

(52) U.S. Cl. 375/240.18

(57) ABSTRACT

The invention relates to a system (101) for content analysis. The system (101) comprises an interface receiving a video signal in accordance with a first encoding standard, such as H.264. The interface is coupled to an extraction processor (107) which extracts video coding data from the video signal. The video coding data is fed to a conversion processor (109) which converts the video coding data to video coding data according to a second video encoding standard, such as MPEG-2. The conversion converts the extracted video data to video coding data related to a common encoding block size, for example, by grouping smaller blocks and averaging the video parameters to provide video coding parameters related to larger block sizes. The converted data is fed to a content analysis processor (111) which performs content analysis based on the converted data. A content analysis algorithm for one video encoding standard may thus be used for a different video encoding standard.

### FIELD OF THE INVENTION

The invention relates to a method and apparatus for content analysis and in particular to a method and apparatus for content analysis based on video encoding parameters.

### BACKGROUND OF THE INVENTION

In recent years, the use of digital storage and distribution of video signals have become increasingly prevalent. In order to reduce the bandwidth required to transmit digital video signals, it is well known to use efficient digital video encoding comprising video data compression whereby the data rate of a digital video signal may be substantially reduced.

In order to ensure interoperability, video encoding standards have played a key role in facilitating the adoption of digital video in many professional- and consumer applications. Most influential standards are traditionally developed by either the International Telecommunications Union (ITU-T) or the MPEG (Motion Pictures Experts Group) committee of the ISO/IEC (the International Organization for Standardization/the International Electrotechnical Committee). The ITU-T standards, known as recommendations, are typically aimed at real-time communications (e.g. videoconferencing), while most MPEG standards are optimized for storage (e.g. for Digital Versatile Disc (DVD)) and broadcast (e.g. for Digital Video Broadcast (DVB) standard).

Currently, one of the most widely used video compression techniques is known as the MPEG-2 (Motion Picture Expert Group) standard. MPEG-2 is a block based compression scheme wherein a frame is divided into a plurality of blocks each comprising eight vertical and eight horizontal pixels. For compression of luminance data, each block is individually compressed using a Discrete Cosine Transform (DCT) followed by quantization which reduces a significant number of the transformed data values to zero. For compression of chrominance data, the amount of chrominance data is usually first reduced by down-sampling, such that for each four luminance blocks, two chrominance blocks are obtained (4:2:0 format), that are similarly compressed using the DCT and quantization. Frames based only on intra-frame compression are known as Intra Frames (I-Frames).

In addition to intra-frame compression, MPEG-2 uses inter-frame compression to further reduce the data rate. Inter-frame compression includes generation of predicted frames (P-frames) based on previous I-frames. In addition, I and P frames are typically interposed by Bidirectional predicted frames (B-frames), wherein compression is achieved by only transmitting the differences between the B-frame and surrounding I- and P-frames. In addition, MPEG-2 uses motion estimation wherein the image of macro-blocks of one frame found in subsequent frames at different positions are communicated simply by use of a motion vector.

As a result of these compression techniques, video signals of standard TV studio broadcast quality level can be transmitted at data rates of around 24 Mbps.

Recently, a new ITU-T standard, known as H.26L, has emerged. H.26L is becoming broadly recognized for its superior coding efficiency in comparison to the existing standards such as MPEG-2. Although the gain of H.26L generally decreases in proportion to the picture size, the potential for its deployment in a broad range of applications is undoubted. This potential has been recognized through formation of the Joint Video Team (JVT) forum, which is responsible for finalizing H.26L as a new joint ITU-T/MPEG standard. The new standard is known as H.264 or MPEG-4 AVC (Advanced Video Coding).

Furthermore, H.264-based solutions are being considered in other standardization bodies, such as the DVB and DVD Forums.

The H.264 standard employs the same principles of block-based motion-compensated hybrid transform coding that are known from the established standards such as MPEG-2. The H.264 syntax is, therefore, organized as the usual hierarchy of headers, such as picture-, slice- and macro-block headers, and data, such as motion-vectors, block-transform coefficients, quantizer scale, etc. However, the H.264 standard separates the Video Coding Layer (VCL), which represents the content of the video data, and the Network Adaptation Layer (NAL), which formats data and provides header information.

Furthermore, H264 allows for a much increased choice of encoding parameters. For example, it allows for a more elaborate partitioning and manipulation of 16×16 macro-blocks whereby e.g. motion compensation process can be performed on segmentations of a macro-block as small as 4×4 in size. Also, the selection process for motion compensated prediction of a sample block may involve a number of stored, previously-decoded pictures, (also known as frames), instead of only the adjacent pictures (or frames). Even with intra coding within a single frame, it is possible to form a prediction of a block using previously-decoded samples from the same frame. Also, the resulting prediction error following motion compensation may be transformed and quantized based on a 4×4 block size, instead of the traditional 8×8 size.

The advent of digital video standards as well as the technological progress in data and signal processing has allowed for additional functionality to be implemented in video processing and storage equipment. For example, recent years have seen significant research undertaken in the area of content analysis of video signals. Such content analysis allows for an automatic determination or estimation of the content of a video signal. The determined content may be used to provide user functionality including filtering, categorisation or organisation of content items. For example, the availability and variability in video content available from e.g. TV broadcasts has increased substantially in recent years, and content analysis may be used to automatically filter and organise the available content into suitable categories. Furthermore, the operation of video equipment may be altered in response to the detection of content. Content analysis may be based on video coding parameters and significant research has been directed towards algorithms for performing content analysis on the basis of in particular MPEG-2 video coding parameters. MPEG-2 is currently the most widespread video encoding standard for consumer applications, and accordingly MPEG-2 based content analysis is likely to become widely implemented.

As a new video encoding standard, such as H.264, is rolled out, content analysis will be required or desired in many applications. Accordingly, content analysis algorithms must be developed which are suitable for the new video encoding standard. This requires significant research and development, which is time consuming and costly. The lack of suitable content analysis algorithms will therefore delay or hinder the uptake of the new video coding standard or significantly reduce the functionality that can be provided for this standard.

Furthermore, existing video systems will need to be replaced or updated in order to introduce new content analysis algorithms. This will also be costly and delay the introduction of the new video coding standard. Alternatively, additional equipment which is operable to decode the signal according to the new video coding standard followed by a re-encoding according to the MPEG-2 video coding standard must be introduced. Such equipment is complex, costly and has a high computational resource requirement.

Accordingly, an improved method of content analysis would be advantageous and in particular a method of content analysis, which has low complexity, facilitates interoperability of equipment, has high flexibility, has low research and development resource requirements, has low computational requirements and/or facilitates introduction of new video coding standards would be advantageous.

### SUMMARY OF THE INVENTION

Accordingly, the Invention preferably seeks to mitigate, alleviate or eliminate one or more of the above mentioned disadvantages singly or in any combination.

According to a first aspect of the invention, there is provided an apparatus for content analysis comprising: means for receiving a first video signal encoded in accordance with a first video encoding format; means for extracting first video coding data from the first video signal, the first video coding data being in accordance with the first video encoding format; means for converting the first video coding data into second video coding data being in accordance with a second video encoding format; and means operable to perform content analysis in response to the second video coding data.

The first video encoding format may be a first video encoding standard like the second video encoding format may be a second video encoding standard.

An apparatus for content analysis which may have low complexity is thus enabled. The apparatus is for example not required to perform a full decoding according to the first video encoding format followed by full encoding according to the second video encoding formattandard. Specifically, full transcoding is not necessary in applications because only a part of the coding parameters involved may be required for the content analysis and for format conversion according to the two formats. The apparatus may furthermore have a high degree of flexibility and for example allow different video encoding formats to be used with the same content analysis algorithms. It may furthermore facilitate interoperability of equipment and may allow for existing content analysis algorithms to be used with new emerging video encoding formats without requiring a full transcoding to the existing video encoding format. It thus facilitates introduction of new equipment into existing video systems. Furthermore, research and development costs associated with content analysis may be significantly reduced in particular by enabling existing content analysis algorithms to be fully or partially reused. Specifically, MPEG-2 content analysis algorithms may be used with an H.264 signal thereby allowing all research and know-how associated with MPEG-2 content analysis to be applicable.

According to a feature of the invention, the means for converting is operable to generate the second video encoding data by converting at least some video coding parameters of the first video coding data relating to a first block encoding size into video coding parameters relating to a second encoding block size compatible with the second video encoding format. This allows for a suitable conversion of video coding parameters and enables the use of content analysis based on a second encoding block size with a video signal encoded using a different encoding block size.

According to another feature of the invention, the means for converting is operable to determine a common encoding block size for the first and second video encoding formats and to convert the at least some video coding parameters of the first video coding data not corresponding to the common encoding block size into video coding parameters corresponding to the common encoding block size. The two video formats may have a common encoding block size and converting the video encoding parameters to this encoding block size provides for a particularly simple and easy to implement conversion which tends to provide the optimum degree of conversion accuracy. The common encoding block size may for example be determined by analysis of the involved signals or video encoding formats or may simply be determined from a predetermined value for a common encoding block size for the first and second video encoding format.

According to another feature of the invention the first and second encoding block sizes are transform block sizes. For example, the encoding block size may be the size of blocks used for Discrete Cosine Transforms (DCTs) used for encoding and/or decoding. This allows for accurate and practical conversions of video coding parameters and is suitable for many content analysis algorithms which utilize transform block parameters.

According to another feature of the invention, the first and second encoding block sizes are prediction block sizes. For example, the encoding block size may be the size of blocks used for motion estimation and prediction according to the video encoding formats. This allows for accurate and practical conversions of video coding parameters and is suitable for many content analysis algorithms which utilize prediction block parameters.

According to another feature of the invention, the first encoding block size is smaller than the second encoding block size and the conversion of the at least some video encoding parameters comprises grouping a plurality of encoding blocks and determining a common video coding parameter for the group. The common parameter may comprise a plurality of sub parameters. For example, the common parameter may comprise a plurality of averaged video encoding parameters, wherein the averaging extends to the encoding blocks comprised in a group. The feature allows for a very efficient, accurate and/or low complexity conversion which may easily be implemented.

According to another feature of the invention, the common video coding parameter comprises a transform coefficient. This allows for efficient conversion of video coding parameters which are suitable for use in content analysis.

According to another feature of the invention, the transform coefficient is a DC (Direct Current) coefficient. A common DC component provides a video coding parameter which is useful in many content analysis algorithms. It is a video coding parameter well suited for grouping and for determining content analysis characteristics of the video signal. Among the transform coefficients that reflect the signal distribution at different frequencies, the DC coefficient corresponds to a frequency of substantially zero. In other words, the DC coefficient represents an average value of the signal that the transform has been applied to.

According to another feature of the invention, the means for converting is operable to determine the common video coding parameter at least partly by averaging at least one DC coefficient of each encoding block in the group. An averaging of DC coefficients provide a particularly suitable indication of the DC properties of the grouped encoding blocks and is therefore particularly useful for content analysis.

According to another feature of the invention, the transform coefficient is an AC (Alternating Current) coefficient. A common AC coefficient provides a video coding parameter which is useful in many content analysis algorithms. It is a video coding parameter well suited for grouping and for determining content analysis characteristics of the video signal. Specifically, AC coefficients may be any other coefficient than the DC coefficient.

According to another feature of the invention, the means for converting is operable to determine the common video coding parameter at least partly by scaling at least one AC coefficient of each encoding block in the group. A scaling of AC coefficients provide a particularly suitable means for generating a common video coding parameter and may in particular compensate for different scalings associated with transforms of different block sizes. The scaling may depend on the transform block size and/or the position of the AC coefficient in the transform block.

According to another feature of the invention, the common video coding parameter comprises a motion vector. A common motion vector provides a video coding parameter which is useful in many content analysis algorithms. It is a video coding parameter well suited for grouping and for determining content analysis characteristics of the video signal.

According to another feature of the invention, the means for converting is operable to determine the common video coding parameter at least partly by averaging at least one motion vector of each encoding block in the group. An averaging of motion vectors provide a particularly suitable indication of the movement properties associated with the grouped encoding blocks and is therefore particularly useful for content analysis.

According to another feature of the invention, the content analysis means is operable to perform content analysis based on only video coding parameters allowed by the second video encoding format. Hence, the invention enables that content analysis algorithms developed exclusively for use with a second video encoding format may be used with a first video encoding format without requiring modifications of the content analysis algorithms.

According to another feature of the invention, the content analysis means is further operable to perform the content analysis in response to video coding parameters of the first video coding data. For example, the content analysis may further take into account different reference picture information, different prediction modes and block sizes and different intra picture modes and block sizes than is available in accordance with the second video encoding format. This allows for an improved content analysis as additional information may be utilised. At the same time, existing content analysis algorithms and/or criterions developed in accordance with only the second video encoding format may be used. Hence, existing algorithms may be gradually improved to take into account the additional information available in accordance with the first video encoding format.

According to another feature of the invention, the first video encoding format is the International Telecommunications Union recommendation H.264 and/or the second video format is the International Organization for Standardization/the International Electrotechnical Committee Motion Picture Expert Group MPEG 2 standard. Specifically, the invention may thus enable content analysis to be performed for an H.264 video signal based on content analysis algorithms and/or criteria developed for MPEG-2 signals.

According to a second aspect of the invention, there is provided a method of content analysis comprising the steps of: receiving a first video signal encoded in accordance with a first video encoding format; extracting first video coding data from the first video signal, the first video coding data being in accordance with the first video encoding format; means for converting the first video coding data into second video coding data being in accordance with a second video encoding format; and performing a content analysis in response to the second video coding data.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 shows a block schematic of an apparatus for content analysis in accordance with an embodiment of the invention; and

FIG. 2 illustrates a flow chart of a method of content analysis in accordance with an embodiment of the invention.

### DESCRIPTION OF PREFERRED EMBODIMENTS

The following description focuses on an embodiment of the invention applicable to a content analysis based on MPEG-2 video coding parameters and in particular to a content analysis of an H.264 encoded video signal based on MPEG-2 video coding parameters. However, it will be appreciated that the invention is not limited to this application and may be used in association with many other video encoding algorithms, specifications or standards including for example: H.263, MPEG-4 ASP (Advanced Simple Profile), Real Player, Quick Time, Windows Media Player and DivX standards.

In the following, references to H.264 comprise a reference to the equivalent ISO/IEC 14496-10 AVC standard often known as MPEG-4 AVC (Advanced Video Coding) or MPEG-4 part 10.

Content analysis has in recent years attracted a lot of attention and significant amounts of research have been undertaken to develop suitable algorithms for content analysis of video signals.

Typically, content analysis is based on detecting specific characteristics typical for a category of content. For example, a video content item may be detected as relating to a football match by having a high average concentration of green colour and a frequent sideways motion. Cartoons are characterised by typically having strong primary colours, a high level of brightness and sharp colour transitions.

Thus video coding parameters may advantageously be used to determine the content of a video signal. For example, a high relative value of AC coefficients in a DCT transform block indicates that a sharp transition is likely to be comprised in the transform block. Such a transition is typical for a cartoon and may therefore be included as a video coding parameter that indicates that the current content is a cartoon. Typically, a significant number of parameters are considered and the content may be determined as the content category which most closely correlates with the determined characteristics. Thus, the colour saturation and luminance may further be included to determine if the current content is a cartoon. For example, if video coding data indicates a high degree of colour saturation, high luminance, a high concentration of energy in high frequency DCT coefficients as well as large uniform or flat picture areas, a content analysis algorithm may determine the current content as a cartoon.

Another example of a video coding parameter that may be useful for content analysis is motion data such as motion vectors. For example, if an area of a picture comprises a very high degree of prediction with small associated motion vectors, this may be an indication that the picture is static for this area and thus that the content of this area is likely to be overlay text or an on-screen logo (e.g. a station logo).

Typically, both video coding parameters and non-video coding parameters may be used together for content analysis. For example, a high degree of motion, strong luminance and a rhythmic nature of an associated sound track may indicate that the current content is a music video.

Further information on content analysis is generally available to the person skilled in the art. For example, the articles “Content-Bases Multimedia Indexing and Retrieval” by C. Djeraba, IEEE Multimedia, April-June 2002, Institute of Electrical and Electronic Engineers; “A Survey on Content-Based Retrieval for Multimedia Databases” by A. Yoshika et al., IEEE Transactions on Knowledge and Data Engineering, vol. 11, No. 1, January/February 1999, Institute of Electrical and Electronic Engineers; “Applications of Video-Content Analysis and Retrieval” by N. Dimitrova et al., IEEE Multimedia, July-September 2002, Institute of Electrical and Electronic Engineers and the therein included references provide an introduction to content analysis.

Efficient, accurate and reliable algorithms for detecting different video content on the basis of parameters generated by an MPEG-2 video encoder have been developed. Therefore, as new video encoding standards emerge, it would be advantageous to be able to re-use these algorithms. For example, it would be advantageous to re-use one, more or all of the developed algorithms or criteria fully or partly for the new video encoding standard H.264. Some of the MPEG-2 parameters will also be present in H.264. However, H.264 also uses additional syntax that is not MPEG-2 compatible, such as for example additional prediction or transform block sizes or a wider range of prediction pictures. A full transcoding between H.264 and MPEG-2 would allow for the video content algorithms of MPEG-2 to be reused. However, this is associated with disadvantages. Specifically, the associated processes, and in particularly the encoding process, tend to be complex and computationally intensive.

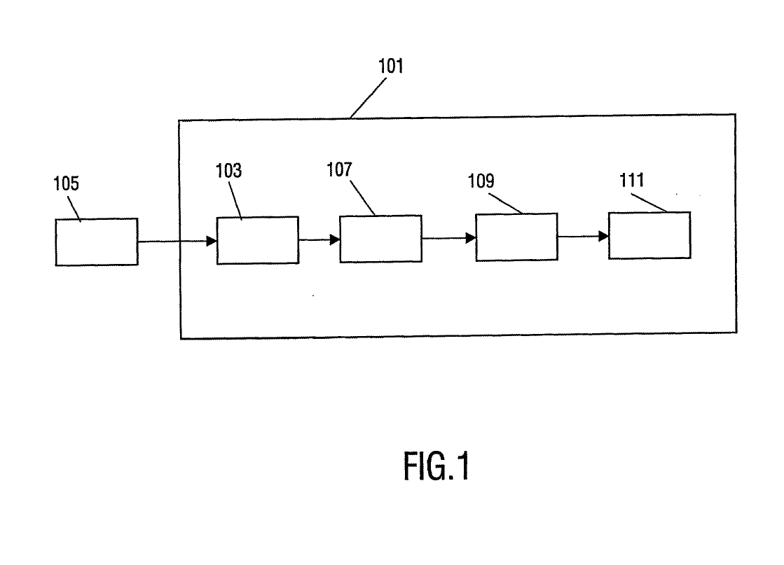

FIG. 1 shows a block schematic of an apparatus for content analysis 101 in accordance with a preferred embodiment of the invention. It will be appreciated that FIG. 1 and the following description for clarity describes separate functional modules or entities. However, the functionality of the apparatus for content analysis 101 may be partitioned and distributed in any suitable manner.

The transcoder comprises an interface 103, which is operable to receive an H.264 encoded video signal. In the shown embodiment, the H.264 video signal is received from an external video source 105. In other embodiments, the video signal may be received from other sources including internal video sources.

The interface 103 is coupled to an extraction processor 107 which is operable to extract video coding data from the H.264 video signal. The extracted video coding data is some or all of the H.264 video encoding data comprised in the H.264 video signal. Hence, the extracted first video coding data is video coding data which in the preferred embodiment is in accordance with the H.264 standard. Specifically, the extraction processor 107 may be implemented as an H.264 decoder and the video coding data may be extracted by H.264 video decoding operations.

The extraction processor 107 is coupled to a conversion processor 109 which is operable to convert the video coding data, which is accordance with the H.264 standard, into video encoding data which is in accordance with the MPEG-2 standard. Hence, corresponding video coding data which is compatible with the MPEG-2 standard is generated on the basis of some or all of the H.264 video encoding data The conversion preferably retains as much information as possible from the H.264 video encoding data. Specifically, the conversion processes and algorithms are preferably such that information useful for content analysis is retained as far as is practical under the constraints of the specific application. The conversion algorithms and criteria are preferably selected such that appropriate information is retained while maintaining a low complexity of the video encoding apparatus. Thus, second video encoding data in accordance with the MPEG-2 video encoding standard is generated by the conversion processor 109 by a conversion of the first video encoding data Preferably, predetermined relationships are used for the conversion. For example, predetermined mathematical formulas or operations may be used to convert one or more of the H.264 video coding parameters into MPEG-2 video coding parameters.

For example, MPEG-2 and H.264 video encoding use a similar syntax for video data up to the level of macro-blocks. At this level, the two video encoding standards mostly differ in the added possibilities of H.264 for partitioning of a macro-block into smaller sub-blocks than possible for MPEG-2. Thus, for example, coding parameters to be used for content analysis may be extracted at the highest block level at which such parameters can exist in both standards i.e. at a common encoding block size. For example, parameters such as motion vectors and DC transform coefficients may be converted into the macro-block level. To achieve this, operations of limited complexity, such as averaging and scaling, may be used.

The conversion performed by the conversion processor 109 may be considered a way of achieving the same granularity of content analysis parameters for the H.264 parameters as for the MPEG-2 parameters. This granularity may be at the macro block level. The conversion processor 109 is coupled to a content analysis processor 111 which is operable to perform a content analysis on the basis of the converted video coding data Thus, the content analysis processor 111 is operable to perform a content analysis based on MPEG-2 video encoding parameters. Any suitable algorithm or criteria for content analysis, which takes video encoding data into account, may be used without detracting from the invention. For example, a content analysis as described in “Real time commercial detection using MPEG-2 features” by N. Dimitrova, S. Jeannin, J. Nesvadba, T. McGee, L. Agnihotri, G. Mekenkamp, Conference Proceedings of the 9th International Conference on Information Processing and Management of Uncertainty in Knowledge-Based Systems, 2002.

In the preferred embodiment, the apparatus for content analysis may thus provide a means for achieving forward compatibility of the current MPEG-2-based algorithms and criteria for content analysis. Likewise, the apparatus for content analysis may provide a means for achieving backwards compatibility for new video encoding standards such as H.264. Such compatibility will facilitate deployment of existing MPEG-2-based solutions in a broader range of applications and/or facilitate deployment of H.264 equipment in existing video systems.

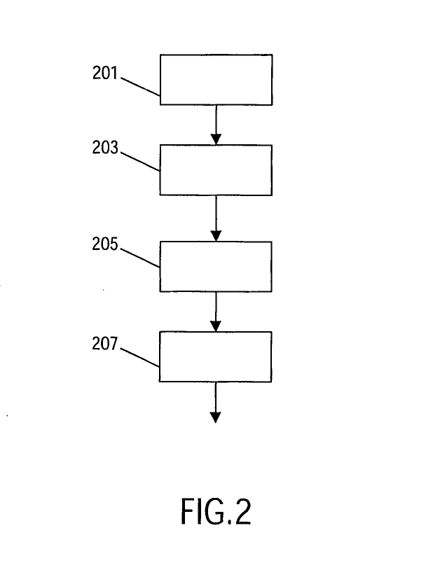

FIG. 2 illustrates a flow chart of a method of content analysis in accordance with a preferred embodiment of the invention. The method is applicable to the apparatus of FIG. 1 and will be described with reference to this.

The method starts in step 201 wherein the interface 103 of the apparatus for content analysis 101 receives an H.264 video signal from the external video source 105.

Step 201 is followed by step 203 wherein the H.264 video signal is fed from the interface 103 to the extraction processor 107 which extracts H.264 video coding data from the H.264 video signal. Specifically, step 203 may comprise a decoding of the H.264 signal in order to extract the relevant video coding data. Algorithms and methods for decoding an H.264 signal are well known in the art and any suitable method and algorithm may be used.

Step 203 is followed by step 205 wherein the H.264 video coding data is converted into video coding data in accordance with the MPEG-2 video encoding standard.

In the preferred embodiment, the conversion comprises converting video coding parameters, which relates to different encoding block sizes than allowed for MPEG-2, into encoding block sizes allowed by MPEG-2. For example, video coding parameters related to four 4×4 encoding blocks may be added together to form a video coding parameter related to one 8×8 MPEG-2 DCT block.

In the preferred embodiment, a common encoding block size is determined for the involved video encoding standards. For example, MPEG-2 and H.264 both comprise 16×16 pixel encoding blocks (macro-blocks). The determination of the common encoding block size may simply be by using a predetermined common encoding block size. For example, information related to a common encoding block size may be comprised in a look up table or may be included as a predetermined value in a software routine. After a common encoding block size has been determined, the video coding parameters are converted into video coding parameters corresponding to the common encoding block size. For example, H.264 data is converted into data corresponding to 16×16 macro blocks.

In some embodiments, the apparatus for content analysis 101 may be operable to receive video signals in accordance with a plurality of different standards. In this case, the apparatus may further comprise means for automatically determining a video encoding standard of a received signal (for example by attempting to decode the video signal in accordance with a plurality of video encoding standards), and the common encoding block size may be determined in response to the detected video encoding standard.

In the preferred embodiment, the encoding block size may relate to transform block sizes. Alternatively or additionally, the encoding block sizes may relate to prediction block sizes.

Both MPEG-2 and H.264 use Discrete Cosine Transforms (DCT) to translate the signal into the spatial frequency domain as is well known to the person skilled in the art. However, whereas MPEG-2 prescribes DCT transforms based on 8×8 pixel blocks, H.264 allows for a larger variety of DCT based transforms to be used. Particularly, DCT transforms may be performed on blocks as small as 4×4 blocks.

In the preferred embodiment, the DCT coefficients of a macro-block are extracted from the H.264 signal. The transform block sizes used in this macro-block is then determined and the transform blocks are grouped together to form 8×8 transform blocks. For example, if an 8×8 region of the macro-block comprises four 4×4 DCT blocks, these four blocks are then grouped together. Consequently, a single common video coding parameter is then determined for this group of 4×4 DCT blocks. The common video coding parameter may comprise a plurality of sub-parameters (or equivalently a plurality of common video coding parameters may be determined).

Specifically, a common DC DCT coefficient may be determined for the group of 4×4 DCT blocks by averaging of the four DC coefficients of the four DCT blocks. The averaged value comprises a reliable measure of the value of the DC coefficient which would have been achieved had an 8×8 DCT been used.

Similarly, the AC coefficients are grouped together by considering the corresponding frequency coefficients in all blocks. However, as is well known in the art, the scaling of the AC coefficients depend on the transform block size and the position of the coefficient, and the AC coefficients are therefore scaled accordingly. Thus, in the preferred embodiment, the AC coefficients are scaled or weighted depending on the size of the transform block size and the position of the coefficient in the transform block. Preferably, the scaling of each coefficient is determined from a look up table comprising predetermined scaling factors.

Similarly, MPEG-2 motion compensation is based on macro block sizes whereas H.264 allows for a much finer granularity of prediction blocks. Specifically, H.264 allows for prediction blocks down to a size of 4×4 pixels. Thus a macro block of H.264 may have a plurality of associated motion vectors corresponding to a plurality of smaller prediction blocks.

In the preferred embodiment, the prediction blocks are grouped together and a single motion vector is determined for the group. Preferably, the common motion vector is generated by averaging the motion vectors of the prediction blocks of the group. Thus a macro block motion vector is generated by averaging the motion vectors of the prediction blocks comprised in the macro-block. Preferably, the motion vectors are weighted in accordance with the size of the prediction blocks. Additionally or alternatively, the motion vectors may be weighted in accordance with the reference picture selection.

Thus in the preferred embodiment, motion vectors and transform coefficients are generated which correspond to estimates of video coding parameters that would have resulted from encoding of the video signal in accordance with the MPEG-2 standard.

Step 205 is followed by step 207 wherein the content analysis processor 111 performs a content analysis in response to converted MPEG-2 data. Any suitable algorithm of content analysis may be used.

In some embodiments, an MPEG-2 only content analysis is used. However, in other embodiments further parameters may be used and in particular parameters which are not compatible with MPEG-2 may be used. For example, H.264 introduces some new types of coding parameters that may improve content analysis accuracy. In particular, object discrimination and tracking may be improved by consideration of these additional parameters. For example, the following additional video coding parameters may be passed to the content analysis processor 111 and used in conjunction with the MPEG-2 converted video coding data:.

Inter Modes:

Smaller encoding block sizes for motion compensationallow for smaller and fast-moving objects to be detected whereas the larger encoding block sizes allow for better detection of larger and static objects (e.g. background). Hence, information about the smaller block sizes of H.264 may be used to improve content analysis and in particular for detection of smaller, fast moving objects.

Intra Modes

H.264 allows for prediction blocks to be within the same picture. Information associated with intra modes may e.g. be useful for refining decisions obtained by other methods. For example, the presence of edges or object boundaries could be indicated by a discontinuity of a limited number of intra modes in that region.

Reference Picture Information

H.264 allows for a wider range of reference pictures to be used for prediction, and this allows for an improved content analysis, for example in situations where picture areas are being covered and uncovered. Hence, a predominant concentration of macro blocks in a localized area with more distant references may be useful for detecting covering and uncovering of objects or background.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. An apparatus (101) for content analysis comprising:
means (103) for receiving a first video signal encoded in accordance with a first video encoding format;
means (107) for extracting first video coding data from the first video signal, the first video coding data being in accordance with the first video encoding format;
means (109) for converting the first video coding data into second video coding data being in accordance with a second video encoding format; and
means (111) operable to perform content analysis in response to the second video coding data.

2. An apparatus as claimed in claim 1, wherein the first video encoding format is a first video encoding standard and wherein the second video encoding format is a second video encoding standard.

3. An apparatus (101) as claimed in claim 1 wherein the means (109) for converting is operable to generate the second video encoding data by converting at least some video coding parameters of the first video coding data relating to a first block encoding size into video coding parameters relating to a second encoding block size compatible with the second video encoding format.

4. An apparatus (101) as claimed in claim 3 wherein the means (109) for converting is operable to determine a common encoding block size for the first and second video encoding formats and to convert the at least some video coding parameters of the first video coding data not corresponding to the common encoding block size into video coding parameters corresponding to the common encoding block size.

5. An apparatus (101) as claimed in claim 3 wherein the first and second encoding block sizes are transform block sizes.

6. An apparatus (101) as claimed in claim 3 wherein the first and second encoding block sizes are prediction block sizes.

7. An apparatus (101) as claimed in claim 3 wherein the first encoding block size is smaller than the second encoding block size and the conversion of the at least some video encoding parameters comprises grouping a plurality of encoding blocks and determining a common video coding parameter for the group.

8. An apparatus (101) as claimed in claim 7 wherein the common video coding parameter comprises a transform coefficient.

9. An apparatus (101) as claimed in claim 8 wherein the transform coefficient is a DC coefficient.

10. An apparatus (101) as claimed in claim 9 wherein the means (109) for converting is operable to determine the common video coding parameter at least partly by averaging at least one DC coefficient of each encoding block in the group.

11. An apparatus (101) as claimed in claim 8 wherein the transform coefficient is an AC coefficient.

12. An apparatus (101) as claimed in claim 11 wherein the means (109) for converting is operable to determine the common video coding parameter at least partly by scaling at least one AC coefficient of each encoding block in the group.

13. An apparatus (101) as claimed in claim 7 wherein the common video coding parameter comprises a motion vector.

14. An apparatus (101) as claimed in claim 13 wherein the means (109) for converting is operable to determine the common video coding parameter at least partly by averaging at least one motion vector of each encoding block in the group.

15. An apparatus (101) as claimed in claim 1 wherein the means (111) operable to perform content analysis is operable to perform content analysis based on only video coding parameters allowed by the second video encoding format.

16. An apparatus (101) as claimed in claim I wherein the means (111) operable to perform content analysis is further operable to perform the content analysis in response to video coding parameters of the first video coding data.

17. A method of content analysis comprising the steps of:
receiving (201) a first video signal encoded in accordance with a first video encoding format;
extracting (203) first video coding data from the first video signal, the first video coding data being in accordance with the first video encoding format;
converting (205) the first video coding data into second video coding data being in accordance with a second video encoding format; and
performing (207) a content analysis in response to the second video coding data.

18. A computer program enabling the carrying out of a method according to claim 17.

19. A record carrier comprising a computer program as claimed in claim 18.
